(19) United States
(12) Patent Application Publication
(10) Pub. No.: US 2023/0333527 A1
(43) Pub. Date: Oct. 19, 2023

(54) ENHANCED CAPACITY MANAGEMENT OF POWER SUPPLIES IN RESPONSE TO ENVIRONMENTAL CONDITIONS

(71) Applicant: Dell Products L.P., Round Rock, TX (US)

(72) Inventors: Craig Anthony Klein, Elgin, TX (US); Wayne Kenneth Cook, Round Rock, TX (US)

(21) Appl. No.: 17/719,546

(22) Filed: Apr. 13, 2022

(51) Int. Cl. G05B 19/042

(52) U.S. Cl. CPC G05B 19/042; G05B 2219/2639

(57) ABSTRACT

An information handling system includes a power supply and a baseboard management controller. The power supply determines a first maximum output power level, determines that an environmental condition of the power supply has changed, determines a second maximum output power level different from the first maximum output power level based upon the changed environmental condition, and stores the second maximum output power level to a first register of the power supply. The baseboard management controller sets a power level demanded by a load of the information handling system to be within the first maximum output power level, reads the first register, and sets the power level demanded by the load to be within the second maximum output power level in response to reading the register.

### FIELD OF THE DISCLOSURE

This disclosure generally relates to information handling systems, and more particularly relates to enhancing capacity management of information handling system power supplies in response to environmental conditions.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a power supply and a baseboard management controller. The power supply may determine a first maximum output power level, determine that an environmental condition of the power supply has changed, determine a second maximum output power level different from the first maximum output power level based upon the changed environmental condition, and store the second maximum output power level to a first register of the power supply. The baseboard management controller may set a power level demanded by a load of the information handling system to be within the first maximum output power level, read the first register, and set the power level demanded by the load to be within the second maximum output power level in response to reading the register.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the current disclosure:

FIGS. 2 and 3 are a flowchart illustrating a method for enhancing capacity management of information handling system power supplies in response to environmental conditions, according to an embodiment of the current disclosure; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

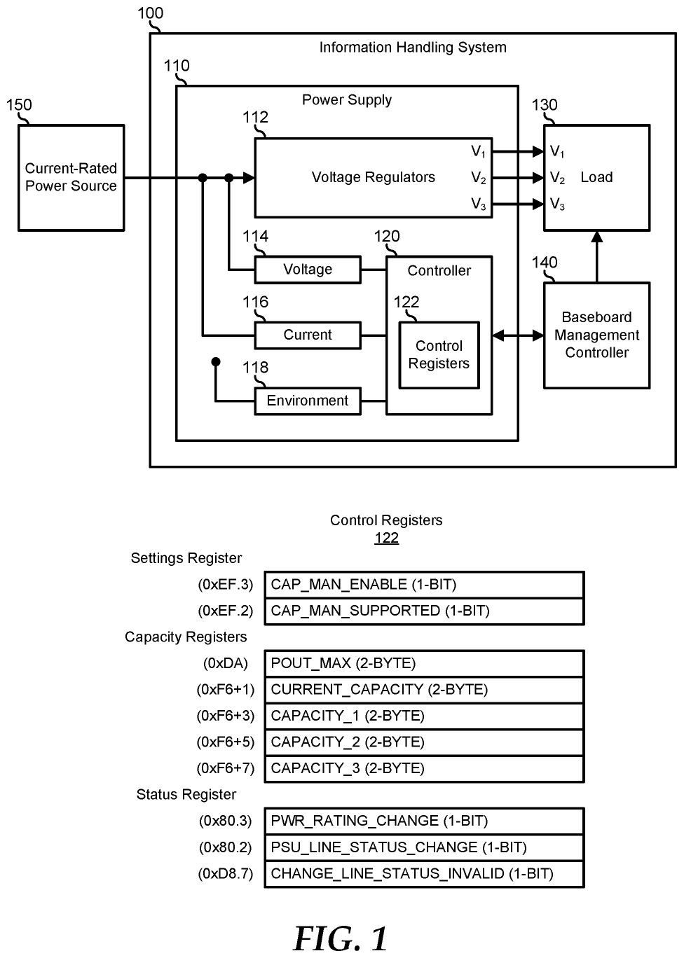

FIG. 1 illustrates and information handling system 100 powered by a current-rated power source 150. Information handling system 100 represents an instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can represent a personal computer, a laptop computer, a smart phone, a tablet device or other consumer electronic device, a network server, a network storage device, a switch router, or other network communication device, or any other suitable device, and may vary in size, shape, performance, functionality, and price. Information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 includes a power supply 110, a load 130, and a baseboard management controller 140. Power supply 110 represents a device for converting input power from current-rated power source 150 at a first voltage two one or more power rails to be provided to load 130. Load 130 represents the components of information handling system 100 that are powered by power supply 110 to provide the functions and features of the information handling system as needed or desired. Power supply 110 includes voltage regulators 112, an input voltage sense circuit 114, an input current sense circuit 116, an environment detection circuit 118, and a controller 120. Voltage regulators 112 represent one or more voltage regulator circuits, each configured to receive the input voltage from current-rated power source 150 and to provide an output voltage on a power rail to load 130.

The voltage regulator circuits may include one or more of a linear voltage regulator, or a switching voltage regulator, such as a buck regulator, a boost regulator, or a buck/boost regulator, as needed or desired. Voltage current sense circuit 114 and input current sense circuit 116 operate to detect the operating conditions of the input voltage from power source slash current-rated power source 150 and provide information related to the input voltage and input current to controller 120. Environment detection circuit 118 operates to sense the environmental conditions within power supply 110 and to provide environmental condition information to controller 120. The environmental condition information may include one or more temperatures within power supply 110, an atmospheric pressure at the power supply, a humidity at the power supply, and altitude of the power supply, or other environmental condition information as needed or desired.

Controller 120 represents an element of power supply 110 configured to control the operation of voltage regulators 112 based upon the input voltage information from input voltage sense circuit 114, the input current information from input current sense circuit 116, the environmental condition information from environment detection circuit 118, And other information as needed or desired. controller 120 includes one or more control registers 122 that provide operational settings, capacity information, status, and control information, based upon which the controller operates. In a particular embodiment, controller 120 represents a circuit device, a logic based device, or a combination thereof. Control registers 122 will be described further below.

Baseboard management controller 140 represents a processing element of information handling system 100 that is configured to monitor, manage, and maintain the operational state of the information handling system. As such, baseboard management controller 140 is connected to controller 120 to monitor, manage, and maintain the power features of information handling system 100. In particular, baseboard management controller 140 operates to detect the power capabilities of power supply 110, and two control the power demand of load 130 based upon the power capabilities of the power supply. for example if voltage sense circuit 114 or current sense circuit 116 detect anomalies on the input from power source slash current-rated power source 150, then baseboard management controller 140 can direct load 130 to reduce the power demand on the voltage rails from power supply 110.

Due to power supply maximum output power limitations and thermal constraints related to input voltage and input connector ratings, power supplies for information handling systems are typically rated at a worst-case operational condition. For example, a 3000 W (output power) capable power supply that is rated to operate at high input line conditions (e.g., 200-240 Vac) may be current limited by an input connector (e.g., a 16 A connector). However, the worst-case input currents and thermal characteristics occur when the input voltage is at or below 200V. Here, assuming the power supply has an efficiency rating of 89% and a power factor rating of 0.98, the 3000 W power supply with draw:

Input Power=3000/(0.89*0.98)=3439.6 W Equation 1.

However, drawing 3439.6 W input power at 200V results in an input current of:

Input Current=3439.6/200=17.2 A Equation 2

which exceeds the rated current of the connector. Thus, at 200V line in, the maximum power supply rating can be determined as follows:

Max Input Power=200*16=3200 Equation 3

and

Max Output Power=3200*(0.89*0.98)=2791 W Equation 4.

As such, a manufacturer of information handling systems is stuck with the option of maintaining multiple inventory line items for 3000 W power supplies, each inventory line item being associated with a different input voltage range and an associated maximum output power, or of maintaining a single inventory line item for 3000 W power supplies, but derating the 3000 W power supplies to 2800 W maximum output power to cover the entire input voltage range.

In a particular embodiment, power supply 110 operates to communicate an output power capacity based upon the operating environment, including the input voltage and current and the environmental conditions of the power supply. For example, when the input voltage is below a particular threshold level, controller 120 can set the output power capacity of power supply 110 at a first level, and when the input voltage is above the threshold level, the controller can set the output power capacity of the power supply at a second, higher level. Controller 120 may operate to provide one or more additional threshold levels, each associated with a different output power capacity level, as needed or desired. Controller 120 then communicates the output capacity of power supply 120 to baseboard management controller 140 that is associated with the particular level of the input voltage, and the baseboard management controller operates to control the power demand of load 130 based upon the received output capacity information. In a particular embodiment, baseboard management controller 140 operates to manage the settings of an Advanced Configuration and Power Interface (ACPI) table instantiated in a BIOS of information handling system 100, or otherwise controls the power demand of load 130, as needed or desired.

FIG. 1 further illustrates an exemplary set of control registers 122 that may be utilized in setting and communicating the output power capacity of power supply 110. Each register location is identified by an exemplary location within a memory map of controller 120. Control registers 122 include one or more settings registers or register locations, one or more capacity registers or register locations, and one or more status registers or register locations, as needed or desired. The settings registers includes a first bit location (0xEF.2) for storing an indication as to whether or not power supply 110 supports or enables the capacity management feature (CAP_MAN_SUPPORTED), and a second bit location (0xEF.3) for storing an indication as to whether or not the capacity management feature of the power supply is currently enabled (CAP_MAN_ENABLED).

The capacity registers further include a 2-byte register location (0xDA) for storing a maximum output power value (POUT_MAX), a 2-byte register location (0xF6+1) for storing a current output power capacity value (CURRENT_CAPACITY), a 2-byte register location (0xF6+3) for storing a first output power value associated with a first input voltage level range (CAPACITY_1), a 2-byte register location (0xF6+5) for storing a second output power value associated with a second input voltage level range (CAPACITY_2), and a 2-byte register location (0xF6+7) for storing a third output power value associated with a third input voltage level range (CAPACITY_3). The status registers include a first bit location (0x80.2) for storing an indication that the input power line status has changed (PSU_LINE_STATUS_CHANGE), and a second bit location (0x80.3) for storing an indication that the output power capacity level has changed (PWR_RATING_CHANGE).

In a particular embodiment, CAP_MAN_SUPPORTED (0xEF.2) is utilized to inform baseboard management controller 140 that power supply 110 supports the capacity management feature as described herein, and CAP_MAN_ENABLED (0xEF.3) is set by the baseboard management controller to enable the capacity management features of the power supply. Here, CAP_MAN_ENABLED (0xEF.3) is provided in order to maintain backward compatibility with systems that do not support the capacity management features. POUT_MAX (0xDA) is a capacity register that may typically be provided in a power supply, and indicates the maximum output power that can be provided by the power supply. In power supply 110, which may be understood to represent a dual 2800/3000 W power supply, POUT_MAX (0xDA) is set to 2800 W and does not change as a function of input voltage. On the other hand, CURRENT_CAPACITY (0xF6+1) is read by baseboard management controller 140 to determine the current output power capacity of power supply 110 when the capacity management features are being utilized. In other words, when CAP_MAN_ENABLED (0xEF.3) is cleared, baseboard management controller 140 reads POUT_MAX (0xDA) to determine the maximum output power of power supply 110, and when CAP_MAN_ENABLED (0xEF.3) is set, the baseboard management controller reads CURRENT_CAPACITY (0xF6+1) to determine the maximum output power of the power supply.

CAPACITY_1 (0xF6+3), CAPACITY_2 (0xF6+5), and CAPACITY_3 (0xF6+7) may be preloaded with output power values associated with the various input voltage level ranges. For example, controller 120 may instantiate a power range for CAPACITY_1 (0xF6+3) of 180-190V and store an output power value of 2800 W, a power range for CAPACITY_2 (0xF6+5) of 190-207V and store an output power value of 2800 W, and a power range for CAPACITY_3 (0xF6+7) of 207-264V and store an output power value of 3000 W.

PSU_LINE_STATUS_CHANGE (0x80.2) is a status register bits that may typically be provided in a power supply, and are implemented in controller 120 as will be understood in the art. There utilization in controller 120 may be further implemented as described below. PWR_RATING_CHANGE (0x80.3) is set by controller 120 when the environmental conditions of power supply 110, and particularly the input voltage level, changes to a degree that the contents of CURRENT_CAPACITY (0xF6+1) are changed by the controller. PWR_RATING_CHANGE (0x80.3) is thus monitored by baseboard management controller 140 to determine when the maximum output power of power supply 110 has changed. Here, when baseboard management controller 140 detects that PWR_RATING_CHANGE (0x80.3) has been set, the baseboard management controller reads CURRENT_CAPACITY (0xF6+1) to determine the new maximum output power of power supply 110, and then clears PWR_RATING_CHANGE (0x80.3).

In a particular embodiment, when power supply 110 is powered on, and the power the power supply has asserted a Vin GOOD signal to indicate that the power received from current-rated power source 150 is stable, baseboard management controller 140 reads CAP_MAN_SUPPORTED (0xEF.2) to determine whether or not the power supply supports the capacity management features. If power supply 110 supports the capacity management features, baseboard management controller 140 has the option to enable the capacity management features on the power supply, by setting CAP_MAN_ENABLED (0xEF.3), or to leave the capacity management features disabled by leaving CAP_MAN_ENABLED (0xEF.3) is in a cleared state.

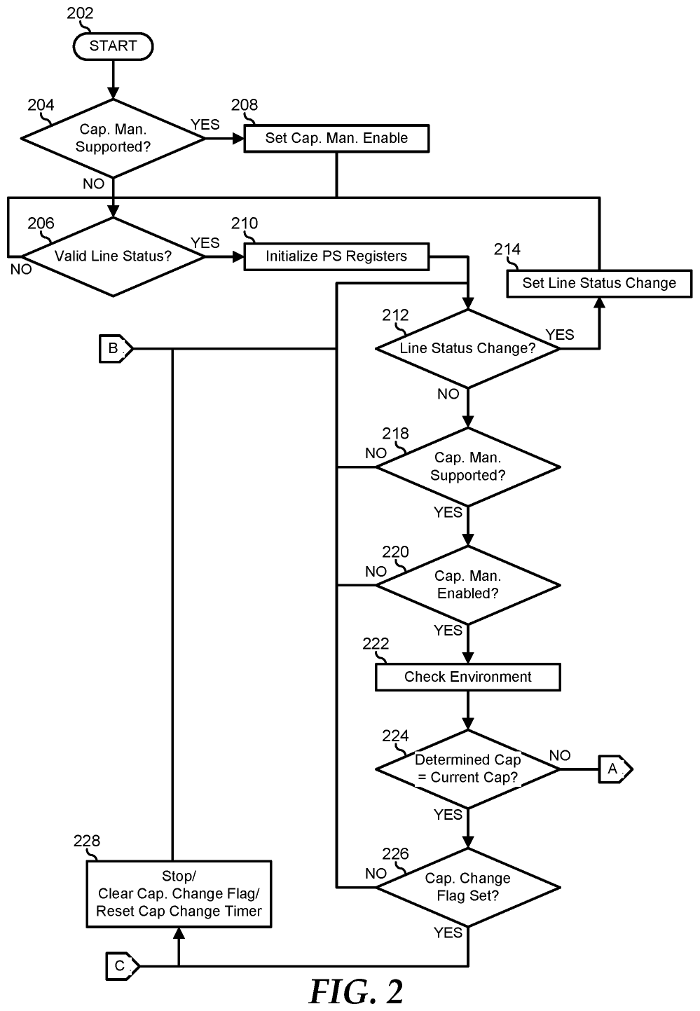

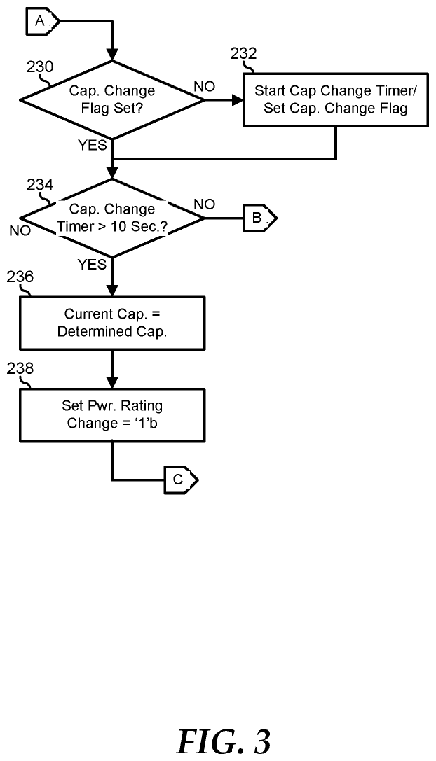

With the capacity management features disabled, controller 120 remains in a loop, operating as a traditional power supply, for example, by remaining under the control of the power line status information, as described further below with respect to the flowchart of FIGS. 2 and 3. In a particular embodiment, even if CAP_MAN_ENABLED (0xEF.3) is a cleared state, controller 120 will maintain the contents of CURRENT_CAPACITY (0xF6+1) as described below, but baseboard management controller 140 will rely on the contents of POUT_MAX (0xDA) in managing the power demands of load 130. In any case, the contents of CAP_MAN_ENABLED (0xEF.3) will be initially loaded with the maximum output power value instantiated in POUT_MAX (0xDA) until such time as the power line conditions change as described below.

In a particular embodiment, when baseboard management controller 140 sets CAP_MAN_ENABLED (0xEF.3), controller 120 manages the output power value that is stored in CURRENT_CAPACITY (0xF6+1) based upon the environmental condition of power supply 110. In particular, controller 120 operates to receive the inputs from input voltage sense circuit 114, input current sense circuit 116, and environment detection circuit 118 to determine a maximum output power capacity of power supply 110 based upon the inputs. For example, where power supply 110 represents a dual 2800/3000 W power supply with a 16 A rated connector, controller 120 may operate to store a value of 2800 W in CURRENT_CAPACITY (0xF6+1) when the line voltage from current-rated power source 150 is below 207V, and to store a value of 3000 W in CURRENT_CAPACITY (0xF6+1) when the line voltage is above 207V.

The contents of CURRENT_CAPACITY (0xF6+1), CAPACITY_1 (0xF6+3), CAPACITY_2 (0xF6+5), and CAPACITY_3 (0xF6+7) may be loaded with any value sufficient to communicate the relevant power levels. For example, controller 120 may store a binary number that is equal to the decimal-based value to be stored, or may store coded values for the digits of the value to be stored, such as by storing the ASCI values of the digits of the decimal-based value to be stored. In another example, controller 120 may store a reduced code of a small number of bits, where each value of the bits is interpreted as a particular power level. For example, where the number of bits is equal to two, a value of 0x00b may be interpreted as 2600 W, a value of 0x01b may be interpreted as 2800 W, a value of 0x10b may be interpreted as 3000 W, and a value of 0x11b may be interpreted as 3200 W. In any case, it will be understood that baseboard management controller 140 will be configured to correctly interpret the contents of CURRENT_CAPACITY (0xF6+1), CAPACITY_1 (0xF6+3), CAPACITY_2 (0xF6+5), and CAPACITY_3 (0xF6+7) based upon the scheme utilized by controller 120.

As noted above, when CAP_MAN_ENABLED (0xEF.3) is cleared, baseboard management controller 140 controls the power demand of load 130 based upon the contents of POUT_MAX (0xDA), which, as further noted above, may store a value that is below the potential maximum output capacity of power supply 110. However, when CAP_MAN_ENABLED (0xEF.3) is set, baseboard management controller 140 controls the power demand of load 130 based upon the contents of CURRENT_CAPACITY (0xF6+1). When the environmental conditions of power supply 110 change to a degree that the output power capacity needs to change, the controller writes the new output power value to CURRENT_CAPACITY (0xF6+1), and sets PWR_RATING_CHANGE (0x80.3). In a particular embodiment, baseboard management controller 140 is configured to periodically pole the value of PWR_RATING_CHANGE (0x80.3) to determine when the output power rating of power supply 110 has changed, and when PWR_RATING_CHANGE (0x80.3) is set, the baseboard management controller reads the new output power rating from CURRENT_CAPACITY (0xF6+1). In another embodiment, controller 120 sends an indication, such as an interrupt or other communication, to baseboard management controller 140 indicating that the value stored in CURRENT_CAPACITY (0xF6+1) has changed.

In a particular embodiment, controller 120 implements a timer with a predetermined duration, such as a 10-second timer. Here, when the environmental conditions of power supply 110 change to a degree that the output power capacity needs to change, controller 120 starts the timer, waits until the timer has expired, and rechecks the environmental conditions of the power supply. Then, if the environmental conditions have relapsed to a state where the output power capacity does not need to change, then controller 120 takes no action on the environmental condition change. However, if, after the expiration of the timer, the environmental conditions remain in the state where the output power capacity needs to change, then controller 120 takes modifies the value of CURRENT_CAPACITY (0xF6+1) and sets PWR_RATING_CHANGE (0x80.3) as described above.

While the actions in response to environmental condition changes of power supply 110 by controller 120, baseboard management controller 140, and other components of information handling system 100 have been described above in the context of line voltage changes, it will be understood that other environmental changes may have an impact on the ability of the power supply to source output power. For example, the temperature of power supply 110 may also impact the ability of the power supply to source output power. As such, it will be understood that controller 120 may provide algorithms and thresholds for other environmental conditions, such as temperature, ambient pressure, humidity, altitude, or the like, as needed or desired.

FIGS. 2 and 3 illustrate a method 200 for enhancing capacity management of information handling system power supply in response to environmental conditions of the power supply, starting at block 202. When an information handling system is powered on, the power supply makes an initial determination as to whether or not the power supply supports the capacity management features in decision block 204. For example, the power supply may determine whether or not CAP_MAN_SUPPORTED (0xEF.2) is set. If the power supply does not support the capacity management features, the “NO” branch of decision block 204 is taken, and a decision is made as to whether or not the input power line status is valid in decision block 206. If the power supply supports the capacity management features, the “YES” branch of decision block 204 is taken, a capacity management enable setting is set in block 208, and the method proceeds to decision block 206 where the decision is made as to whether or not the input power line status is valid. An example of setting the management enable setting may include setting CAP_MAN_ENABLED (0xEF 0.3).

If the input power line status is not valid, the “NO” branch of decision block 206 is taken and the method loops to decision block 206 until the input power line status is valid. When the input power line status is valid, the “YES” branch of decision block 206 is taken, and the power supply is initialized in block 210. An example of initializing the power supply may include storing a maximum output power value in POUT_MAX (0xDA), setting environmental condition thresholds, storing the value of POUT_MAX (0xDA) to CURRENT_CAPACITY (0xF6+1), and other activities for initializing a power supply, as needed or desired.

After power supply is initialized in block 210, a decision is made as to whether or not the input power line status has changed in decision block 212. If so, the “YES” branch of decision block 212 is taken, a line status change indication is provided in block 214, and the method returns to decision block 206 where a decision is made as to whether or not the input power line status is valid. For example, PSU_LINE_STATUS_CHANGE (0x80.2) can be set. When the input power line status is unchanged, the “NO” branch of decision block 212 is taken and a decision is made as to whether or not the power supply supports the capacity management features in decision block 218. For example, the power supply may determine whether or not CAP_MAN_SUPPORTED (0xEF.2) is set. If not, the “NO” branch of decision block 218 is taken and the method loops back to decision block 212. If the power supply supports the capacity management features, the “YES” branch of decision block 218 is taken and a decision is made as to whether or not the capacity management features of the power supply are enabled in decision block 220. An example of setting the management enable setting may include setting CAP_MAN_ENABLED (0xEF.3). If not, the “NO” branch of decision block 220 is taken and the method loops back to decision block 212.

To this point in method 200, the behavior of the power supply will match that of the traditional power supply until such time as the power supply is determined to support the capacity management features, and the capacity management features are enabled. When the capacity management features are determined to be enabled, the “YES” branch of decision block 220 is taken, and the environmental conditions of the power supply are checked in block 222. An example of checking the environmental conditions may include checking the input line voltage, the input line current, the temperature, the pressure, the humidity, the altitude, or the like. In block 222, the environmental condition check will be performed based upon various environmental condition thresholds, such as an input voltage threshold, or other thresholds, as needed or desired. In response to the environmental condition check, block 222 will be further understood to make a determination of an output power capacity of the power supply based upon the environmental conditions of the power supply.

After the environmental conditions of the power supply are checked in block 222, a decision is made as to whether or not the determined output power capacity of the power supply is equal to the current output power capacity in decision block 224. For example, the result of the environmental condition check may be compared to the contents of CURRENT_CAPACITY (0xF6+1). If the determined output power capacity of the power supply is not equal to the current output power capacity, the “NO” branch of decision block 224 is taken and a decision is made as to whether or not a capacity change flag is set in decision block 230. If not, the “NO” branch of decision block 230 is taken, the capacity change flag is set and a capacity change timer is started in block 232, and the method proceeds to decision block 234. An example of a capacity change timer may include a 10-second timer. After the capacity change flag is set and the capacity change timer is started in block 232, or when the capacity change flag is determined to be set and the “YES” branch of decision block 230 is taken, a decision is made as to whether or not the capacity change timer has expired in decision block 234. If not, the “NO” branch of decision block 234 is taken and the method returns to decision block 212 where a decision is made as to whether or not the input power line status has changed.

When the capacity change timer has expired, the “YES” branch of decision block 234 is taken, and the determined output capacity value from block 222 is stored as the current output capacity value in block 236. For example, the determined output capacity value may be stored to CURRENT_CAPACITY (0xF6+1). A power rating change indication is provided in block 238. For example, PWR_RATING_CHANGE (0x80.3) can be set. After the power rating change indication is provided in block 238, the method proceeds to block 228 as described below.

Returning to decision block 224, when the determined output power capacity of the power supply, as determined in block 222, is equal to the current output power capacity, the “YES” branch of decision block 224 is taken and a decision is made as to whether or not the capacity change flag is set in decision block 228. If not, the “NO” branch of decision block 228 is taken and the method returns to decision block 212 where a decision is made as to whether or not the input power line status has change. After the power rating change indication is provided in block 238, or when the capacity change flat is set, and the “YES” branch od decision block 226 is taken, the environmental check is stopped, the capacity change flag is cleared, and the capacity change timer is reset in block 228, and the method returns to decision block 212 where a decision is made as to whether or not the input power line status has change.

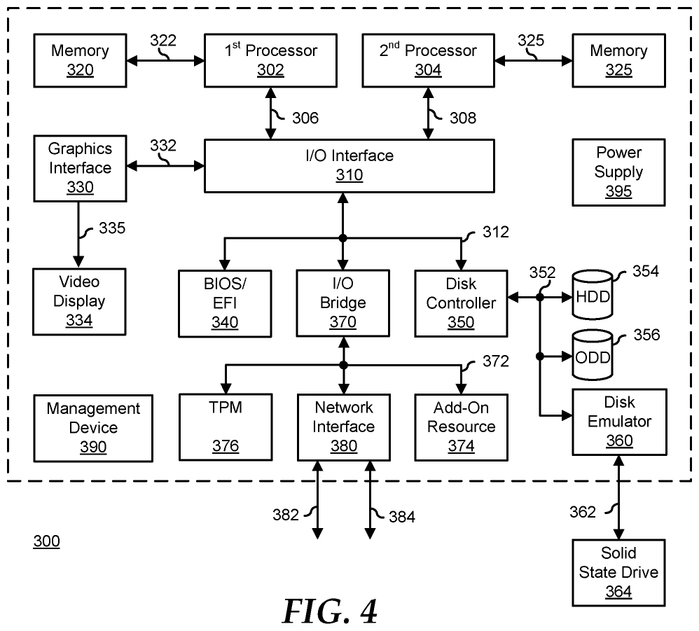

FIG. 4 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a power supply configured to determine a first maximum output power level, to determine that an environmental condition of the power supply has changed, to determine a second maximum output power level different from the first maximum output power level based upon the changed environmental condition, and to store the second maximum output power level to a first register of the power supply; and
a baseboard management controller configured to set a power level demanded by a load of the information handling system to be within the first maximum output power level, to read the first register, and to set the power level demanded by the load to be within the second maximum output power level in response to reading the register.

2. The information handling system of claim 1, wherein the power supply is further configured to instantiate a first range of environmental conditions.

3. The information handling system of claim 2, wherein in determining that the environmental condition of the power supply has changed, the power supply is further configured to determine that environmental condition is outside of the first range.

4. The information handling system of claim 3, wherein the power supply is further configured to instantiate a second range of environmental conditions different from the first range.

5. The information handling system of claim 4, wherein the power supply is further configured to determine that environmental condition is outside of both the first range and the second range.

6. The information handling system of claim 5, wherein the power supply is further configured to determine a third maximum output power level different from the first maximum output power level and the second maximum power level, and to store the third maximum output power level to the first register in response to determining that environmental condition is outside of both the first range and the second range.

7. The information handling system of claim 1, wherein the first maximum output power level is a default output power level.

8. The information handling system of claim 7, wherein, upon power up of the information handling system, the power supply is further configured to store the default output power level to a second register of the power supply.

9. The information handling system of claim 8, wherein, prior to setting the power level demanded by the load to be within the first maximum output power level, the baseboard management controller is further configured to read the second register, and wherein setting the power level demanded by the load to be within the first maximum output power level is in response to reading the second register.

10. The information handling system of claim 1, wherein the environmental condition includes one of an input voltage to the power supply, an input current to the power supply, and a temperature of the power supply.

11. A method, comprising:
determining, by a power supply of an information handling system, a first maximum output power level;
determining that an environmental condition of the power supply has changed, to determine a second maximum output power level different from the first maximum output power level based upon the changed environmental condition;
storing the second maximum output power level to a first register of the power supply;
setting, by a baseboard management controller of the information handling system, a power level demanded by a load of the information handling system to be within the first maximum output power level;
reading the first register; and
setting the power level demanded by the load to be within the second maximum output power level in response to reading the register.

12. The method of claim 11, further comprising instantiating, by the power supply, a first range of environmental conditions.

13. The method of claim 12, wherein in determining that the environmental condition of the power supply has changed, the method further comprises determining that environmental condition is outside of the first range.

14. The method of claim 13, further comprising instantiating, by the power supply, a second range of environmental conditions different from the first range.

15. The method of claim 14, further comprising determining that environmental condition is outside of both the first range and the second range.

16. The method of claim 15, further comprising:
determining a third maximum output power level different from the first maximum output power level and the second maximum power level; and
storing the third maximum output power level to the first register in response to determining that environmental condition is outside of both the first range and the second range.

17. The method of claim 11, wherein the first maximum output power level is a default output power level.

18. The method of claim 17, further comprising storing, upon power up of the information handling system, the default output power level to a second register of the power supply.

19. The method of claim 18, wherein prior to setting the power level demanded by the load to be within the first maximum output power level, the method further comprises reading the second register, wherein setting the power level demanded by the load to be within the first maximum output power level is in response to reading the second register.

20. A power supply for an information handling system, the power supply comprising:
a first register to store a first maximum output power level, the first maximum output power level being a default maximum output power level for the power supply;
a second register to store; and
a controller configured to store the default maximum output power level to the second register, to determine that an environmental condition of the power supply has changed, to determine a second maximum output power level different from the first maximum output power level based upon the changed environmental condition, and to store the second maximum output power level to the second register.
